(19) United States
(12) Patent Application Publication
(10) Pub. No.: US 2017/0022816 A1
(43) Pub. Date: Jan. 26, 2017

(54) MIM-FORMED TiA1 TURBINE WHEEL SURROUNDING A CAST/MACHINED CORE

(71) Applicant: BorgWarner Inc., Auburn Hills, MI (US)

(72) Inventor: Brock Fraser, Asheville, NC (US)

(21) Appl. No.: 14/808,305

(22) Filed: Jul. 24, 2015

(51) Int. Cl. F01D 5/02; B22F 7/04; B22F 3/02; B22D 19/00

(52) U.S. Cl. CPC F01D 5/02; B22D 19/0054; B22F 7/04; B22F 3/02; F05D 2220/30; F05D 2230/21; F05D 2230/30; F05D 2250/232

(57) ABSTRACT

A number of variations may include a method that may include casting or providing a central core comprising titanium aluminide; and metal injection molding a shell comprising titanium aluminide around the central core to produce a rotor assembly.

### TECHNICAL FIELD

The field to which the disclosure generally relates includes metal-injection-molded (MIM) turbine wheels.

### BACKGROUND

Manufacturing turbine wheels or rotor assemblies including a core and turbine blades may have poor yield and high scrap rate due to difficulties in the manufacturing process.

### SUMMARY OF ILLUSTRATIVE VARIATIONS

A number of variations may include a method that may include casting or providing a central core that may include titanium aluminide and metal injection molding a shell that may include titanium aluminide around the central core to produce a rotor assembly.

Another variation may include a method that may include machining a central core that may include titanium aluminide and metal injection molding a shell that may include titanium aluminide around the central core to produce a rotor assembly.

Another variation may include a product that may include a rotor assembly that may include a cast titanium aluminide central core and a metal injection molded titanium aluminide shell radially surrounding the central core.

Another variation may include a product that may include a rotor assembly that may include a machined titanium aluminide central core and a metal injection molded titanium aluminide shell radially surrounding the central core wherein the shell may include a plurality of blades.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts a top-down view of one variation of a MIM-formed turbine wheel surrounding a core; and

FIG. 2 depicts a cross-sectional view of one variation of a MIM-formed turbine wheel surrounding a core.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

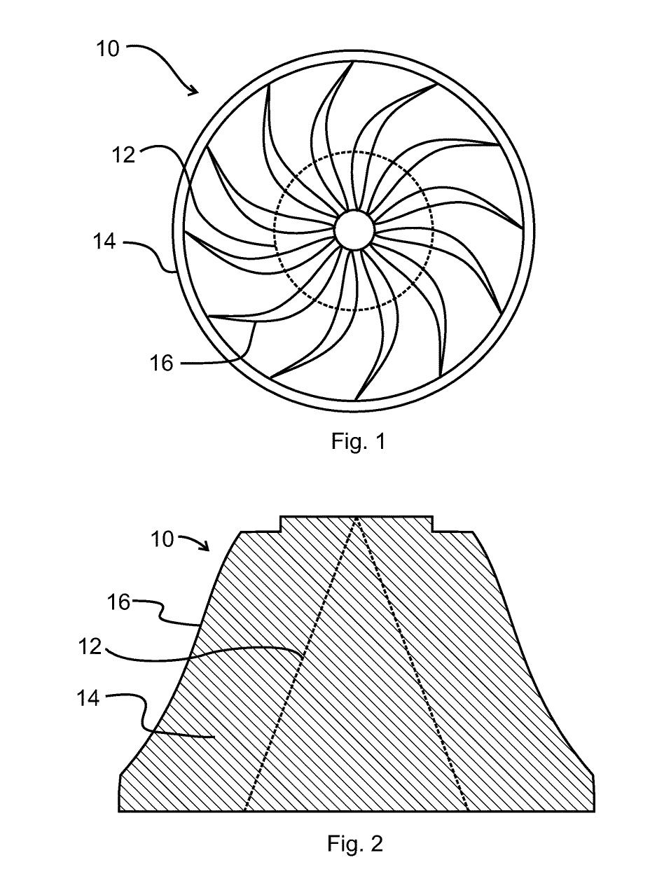

Referring to FIG. 1; a rotor assembly 10 may include a core 12 surrounded by a shell 14 wherein the shell may include a plurality blades 16.

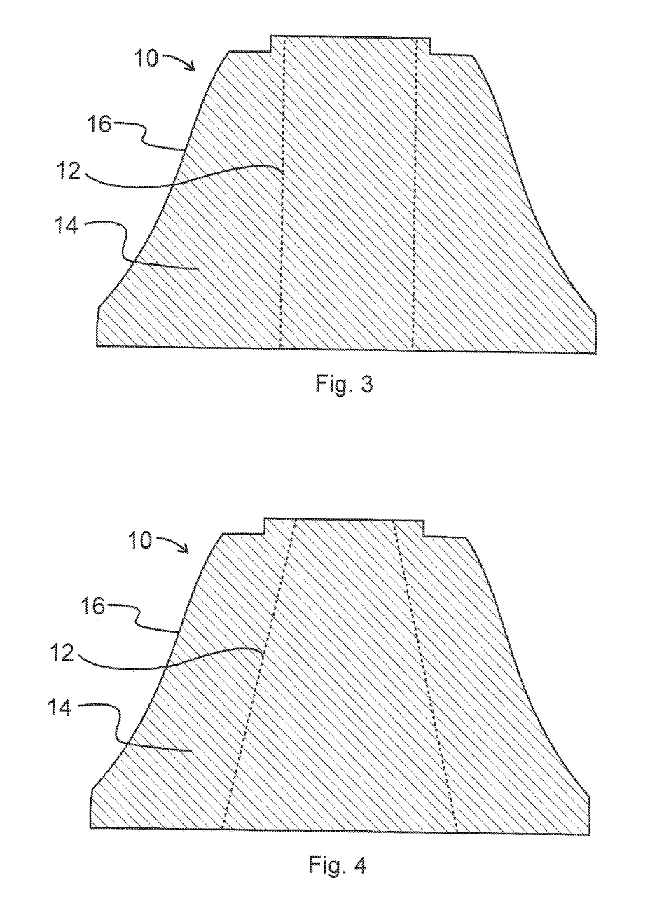

Referring to FIG. 2; the core 12 may be generally cone-like in shape. Alternatively, the core 12 may be generally cylindrical in shape or in the shape of a truncated cone. One of ordinary skill in the art will appreciate that other shapes of the core 12 are contemplated by and fall within the scope of this disclosure.

The rotor assembly 10 may be a propeller, impeller (as depicted in FIGS. 1 and 2), fan, or rotor for use in a pump, turbine, or similar device. The rotor assembly 10 may include a core 12 which is surrounded by a shell 14. The shell 14 may make up a portion of the rotor assembly 10 including at least a plurality of blades 16 but may include additional structure such as a base of an impeller, and through-channel, or other similar structures.

The plurality of blades 16 may be the blades of propeller, impeller, fan, or rotor for use in a pump, turbine, or similar device which may be constructed and arranged to facilitate the flow of fluid.

According to one variation, a method of forming the rotor assembly 10 may include first cast, machining, or casting and machining a core 12 of titanium aluminide (TiAl) in a generally cone, truncated cone, or cylindrical shape. The method may further include metal injection molding the shell 14 around the core 12 where in the shell is made up of TiAl. The method may further include machining or sintering the shell 12 to complete the rotor assembly.

According to variation 1, a method may include casting a central core that may include titanium aluminide and metal injection molding a shell that may include titanium aluminide around the central core to produce a rotor assembly.

Variation 2 may include a product as set forth in variation 1 wherein the shell may include a plurality of blades.

Variation 3 may include a product as set forth in variation 1 or 2 wherein the central core may be generally cone shaped.

Variation 4 may include a product as set forth in any of variations 1 through 3 wherein the central core may be generally shaped like a truncated cone.

Variation 5 may include a product as set forth in any of variations 1 through 4 wherein the central core may be generally cylinder shaped.

Variation 6 may include a product as set forth in any of variations 1 through 5 and may further include sintering the rotor assembly.

According to variation 7, a method may include machining a central core that may include titanium aluminide and metal injection molding a shell that may include titanium aluminide around the central core to produce a rotor assembly.

Variation 8 may include a product as set forth in variation 7 wherein the shell may include a plurality of blades.

Variation 9 may include a product as set forth in any of variations 7 through 8 wherein the central core may be generally cone shaped.

Variation 10 may include a product as set forth in any of variations 7 through 9 wherein the central core may be generally shaped like a truncated cone.

Variation 11 may include a product as set forth in any of variations 7through 10 wherein the central core may be generally cylinder shaped.

Variation 12 may include a product as set forth in any of variations 7 through 11 and may further include sintering the rotor assembly.

According to variation 13, a product may include a rotor assembly that may include a cast titanium aluminide central core and a metal injection molded titanium aluminide shell radially surrounding the central core.

Variation 14 may include a product as set forth in variation 13 wherein the shell may include a plurality of blades.

Variation 15 may include a product as set forth in any of variations 13 through 14 wherein the central core may be generally cone shaped.

Variation 16 may include a product as set forth in any of variations 13 through 15 wherein the central core may be generally shaped like a truncated cone.

Variation 17 may include a product as set forth in any of variations 13 through 16 wherein the central core may be generally cylinder shaped.

According to variation 18, a product may include a rotor assembly that may include a machined titanium aluminide central core and a metal injection molded titanium aluminide shell radially surrounding the central core wherein the shell may include a plurality of blades.

Variation 19 may include a product as set forth in variation 18 wherein the central core may be generally cone shaped.

Variation 20 may include a product as set forth in any of variations 18 through 19 wherein the central core may be generally shaped like a truncated cone.

Variation 21 may include a product as set forth in any of variations 18 through 20 wherein the central core may be generally cylinder shaped.

The above description of variations within the scope of the invention is merely demonstrative in nature and, thus, variations thereof are not to be regarded as a departure from the spirit and scope of the inventions disclosed within this document.

1. A method comprising:
casting a central core comprising titanium aluminide; and
metal injection molding a shell comprising titanium aluminide around the central core to produce a rotor assembly.

2. A method as set forth in claim 1 wherein the shell comprises a plurality of blades.

3. A method as set forth in claim 1 wherein the central core is generally cone shaped.

4. A method as set forth in claim 1 wherein the central core is generally shaped like a truncated cone.

5. A method as set forth in claim 1 wherein the central core is generally cylinder shaped.

6. A method as set forth in claim 1 further comprising sintering the rotor assembly.

7. A method comprising:
machining a central core comprising titanium aluminide; and
metal injection molding a shell comprising titanium aluminide around the central core to produce a rotor assembly.

8. A method as set forth in claim 7 wherein the shell comprises a plurality of blades.

9. A method as set forth in claim 7 wherein the central core is generally cone shaped.

10. A method as set forth in claim 7 wherein the central core is generally shaped like a truncated cone.

11. A method as set forth in claim 7 wherein the central core is generally cylinder shaped.

12. A method as set forth in claim 7 further comprising sintering the rotor assembly.

13. A product comprising:
A rotor assembly comprising a cast titanium aluminide central core; and a metal injection molded titanium aluminide shell radially surrounding the central core.

14. A product as set forth in claim 13 wherein the shell comprises a plurality of blades.

15. A product as set forth in claim 13 wherein the central core is generally cone shaped.

16. A method as set forth in claim 13 wherein the central core is generally shaped like a truncated cone.

17. A method as set forth in claim 13 wherein the central core is generally cylinder shaped.

18. A product comprising:
A rotor assembly comprising a machined titanium aluminide central core; and a metal injection molded titanium aluminide shell radially surrounding the central core wherein the shell comprises a plurality of blades.

19. A product as set forth in claim 12 wherein the central core is generally cone shaped.

20. A method as set forth in claim 1 wherein the central core is generally shaped like a truncated cone.

21. A method as set forth in claim 1 wherein the central core is generally cylinder shaped.
